(19) United States
(12) Patent Application Publication
(10) Pub. No.: US 2013/0189553 A1
(43) Pub. Date: Jul. 25, 2013

(54) CELL HOUSING FOR ELECTROCHEMICAL CELLS FOR ASSEMBLY OF AN ELECTROCHEMICAL ENERGY STORAGE

(71) Applicant: Li-Tec Battery GmbH, Kamenz (DE)

(72) Inventor: Michael Enghardt, Dresden (DE)

(73) Assignee: LI-TEC BATTERY GMBH, Kamenz (DE)

(21) Appl. No.: 13/742,592

(22) Filed: Jan. 16, 2013

Related U.S. Application Data
(60) Provisional application No. 61/587,696, filed on Jan. 18, 2012.

(30) Foreign Application Priority Data
Jan. 18, 2012 (DE) 10 2012 000 871.6

(51) Int. Cl. H01M 2/10; H01M 10/50

(52) U.S. Cl. CPC H01M 2/1077; H01M 10/50
USPC 429/87

(57) ABSTRACT

A cell housing for an electrochemical cell for assembly of an electrochemical energy storage, particularly configured for use in a motor vehicle, which is of substantially rigid configuration and comprises a first housing side wall and a second housing side wall opposite said first housing side wall. The first housing side wall further comprises a first coolant channel and the second housing side wall further comprises a second coolant channel.

The present application claims the benefit of U.S. Provisional Patent Application Ser. No. 61/587,696, filed Jan. 18, 2012, the entire content of which is hereby incorporated by reference. The present application also claims priority to German Patent Application No. 10 2012 000 871.6, filed Jan. 18, 2012, the entire content of which is hereby incorporated by reference.

The present invention relates to a cell housing for electrochemical cells for assembly of an electrochemical energy storage, particularly an energy storage for use in a motor vehicle.

Batteries (primary storages) and accumulators (secondary storages) assembled from one or more storage cells are known as electrochemical energy storages, in which when a charging current is applied, electrical energy is converted into chemical energy in an electrochemical charge reaction between a cathode and an anode in or between an electrolyte and thus stored, and in which when connected to an electrical load, chemical energy is converted into electrical energy in an electrochemical discharge reaction. In this process, primary storages are usually only charged once and disposed of after being discharged whereas secondary storages allow a plurality of charge/ discharge cycles (from several 100 to more than 10,000). It is to be noted in conjunction hereto that accumulators are also called batteries, particularly in the automotive sector.

Batteries on the one hand generate heat as a result of being charged and discharged, whereby the converted heat is to be dissipated in order to prevent heat from accumulating and so as to maintain an optimum operating temperature for the battery. On the other hand, it can be advantageous given low temperatures to increase the battery's operating temperature in order to reach the optimum operating temperature. Operating a battery within the range of its optimal operating temperature extends its service life and improves its electrical efficiency.

An object of the present invention is thus to provide an improved cell housing for electrochemical cells for assembling an electrochemical energy storage and a correspondingly improved battery.

This object is accomplished by a cell housing in accordance with claim 1, respectively a battery according to claim 9. Advantageous embodiments and further developments constitute the subject matter of the dependent claims.

The object of the invention is accomplished by a cell housing for an electrochemical cell for assembly of an electrochemical energy storage, preferably configured for use in a motor vehicle, wherein the cell housing is of substantially rigid configuration and exhibits a first housing side wall and a second housing side wall opposite the first housing side wall, by virtue of the first housing side wall comprising a first coolant channel and the second housing side wall comprising a second coolant channel with a coolant flow connection from the first coolant channel of the first housing side wall to the second coolant channel of the second housing side wall being arranged in the cell housing. One general advantage of this configuration is thus being able to reduce the number of components required for controlling the temperature of the electrochemical cells and hence simplifying the assembly of the electrochemical energy storage. One particular advantage of this configuration is that it allows for dispensing with components such as e.g. cooling plates and/or heat conducting films. Another advantage of this configuration is that it simplifies the assembly of the electrochemical energy storage because no separate coolant line is needed between the electrochemical cells. A further advantage of this configuration is being able to reduce the space required for controlling the temperature of the electrochemical cells.

To be understood by an “electrochemical energy storage” is any type of energy storage device which can absorb electrical energy, wherein an electrochemical reaction occurs in the interior of the energy storage. The term encompasses energy storages of all types, in particular primary batteries and secondary batteries. The electrochemical energy storage apparatus comprises at least one electrochemical cell, preferentially a plurality of electrochemical cells. The plurality of electro-chemical cells can be connected in parallel to store a larger amount of charge or connected in series to obtain a desired operating voltage or can form a combination parallel/series connection.

To be understood by an “electrochemical cell” is thereby an apparatus which serves in emitting electrical energy, wherein the energy is stored in chemical form. In the case of rechargeable secondary batteries, the cell is also configured to absorb electrical energy, convert it into chemical energy and store it. The configuration (i.e. particularly the size and the geometry) of an electrochemical cell can be selected as a function of the available space. The electrochemical cell is preferentially of substantially prismatic or cylindrical configuration.

Such an electrochemical cell usually comprises an electrode assembly which is at least partly enclosed by a casing. In the present context, an electrode assembly is to be understood as an array of at least two electrodes with an electrolyte arranged between them. The electrolyte can be partly accommodated by a separator, whereby the separator then separates the electrodes. The electrode assembly preferentially comprises a plurality of electrode/separator layers, wherein the respective electrodes of like polarity are preferably electrically interconnected, in particular connected in parallel. The electrodes are of e.g. plate-shaped or film-like configuration and are preferentially arranged substantially parallel to one another (prismatic energy storage cells). The electrode assembly can be also coiled and have a substantially cylindrical shape (cylindrical energy storage cells). The term electrode assembly is also to encompass such electrode coils. The electrode assembly can comprise lithium or another alkali metal, also in ionic form.

The coolant flow connection is preferentially disposed at one end of the first coolant channel and at another end of the second coolant channel. A further advantage of this arrangement is that a better coolant flow can be achieved. Another advantage of this arrangement is that no separate seals or screws are necessary because the coolant flow runs through the electrochemical cell within a sealed area.

The first coolant channel is preferentially of substantially meandering form over virtually the entire first housing side wall in the cell housing. It is further preferential for the second coolant channel to be of substantially meandering form over virtually the entire second housing side wall. One advantage of this configuration is that a larger cooling surface for the electrochemical cells and a lower temperature gradient within the electrochemical cells can be achieved.

The first coolant channel and the second coolant channel are preferably of symmetrical configuration in the cell housing. One advantage of this configuration is that it simplifies the assembly of the electrochemical energy storage.

With respect to the cell housing, it is preferred to configure the first housing side wall of the one cell housing to contact a first housing side wall of an adjacently arranged cell housing. It is further preferred to configure the second housing side wall of the one cell housing to contact a second housing side wall of an adjacently arranged cell housing. One advantage of this configuration is that it can improve the mechanical connection of the electrochemical cells.

With respect to the cell housing, it is preferred to configure the first coolant channel such that a connection of the first housing side wall of the one cell housing to a first housing side wall of the adjacently arranged cell housing forms a common coolant channel. It is further preferred to configure the second coolant channel such that a connection of the second housing side wall of the one cell housing to the second housing side wall of the adjacently arranged cell housing forms a common coolant channel. One advantage of this configuration is that it can improve the coolant flow.

With respect to the cell housing, it is preferred for the first housing side wall to comprise a first sealing member enclosing the first coolant channel, wherein said first sealing member of the one cell housing is configured to connect to a first sealing member of the adjacently arranged cell housing. It is further preferred for the second housing side wall to comprise a second sealing member enclosing the second coolant channel, wherein said second sealing member of the one cell housing is configured to connect to a second sealing member of the adjacently arranged cell housing. One advantage of this configuration is that it can improve the sealing of the coolant channels.

With the present cell housing, it is preferential for the first sealing member to comprise a first groove surrounding the first coolant channel. It is further preferential for the second sealing member to comprise a second groove surrounding the second coolant channel. One advantage of this configuration is that a particularly stable sealing can be realized.

The present object is accomplished by a battery having at least two electrochemical cells in which the electrochemical cells comprise the above-described cell housings and are arranged such that the respective first housing side wall of the one cell housing is connected to the first housing side wall of the adjacently arranged cell housing and/or that the respective second housing side wall of the one cell housing is connected to the second housing side wall of the adjacently arranged cell housing. An advantage of this configuration is that it can simplify the battery's assembly.

With respect to the battery, it is preferential for the respective first sealing member of the one cell housing to contact the first sealing member of the adjacently arranged cell housing and a sealing strip to be inserted into the first groove of the first sealing member of the one cell housing and/or into the first groove of the first sealing member of the adjacently arranged cell housing. It is further preferred for the respective second sealing member of the one cell housing to contact the second sealing member of the adjacently arranged cell housing and a sealing strip to be inserted into the second groove of the second sealing member of the one cell housing and/or into the second groove of the second sealing member of the adjacently arranged cell housing. One advantage of this configuration is that it can improve the coolant flow and the cooling action, particularly when the electrochemical cells are in a series connection.

It is particularly preferential for the sealing strip to comprise at least one precompressed strip element which expands preferably slowly after being inserted into the groove. One advantage to this configuration is the improved sealing of the coolant channel. A further advantage of this configuration is that it can improve the connection between adjacent cell housings.

Further advantages, features and possible applications of the present invention can be seen by the following description in conjunction with the drawings. Shown are:

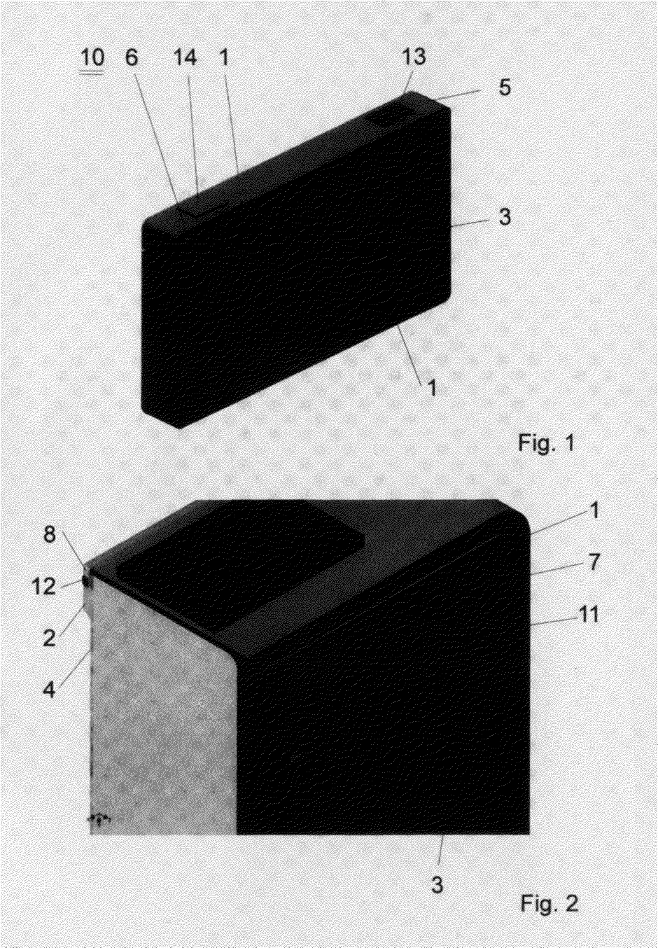

FIG. 1 a schematic depiction of a cell housing according to an embodiment of the present invention in a perspective view;

FIG. 2 a first detail depiction of the cell housing shown in FIG. 1;

FIG. 3 a second detail depiction of the cell housing shown in FIG. 1; and

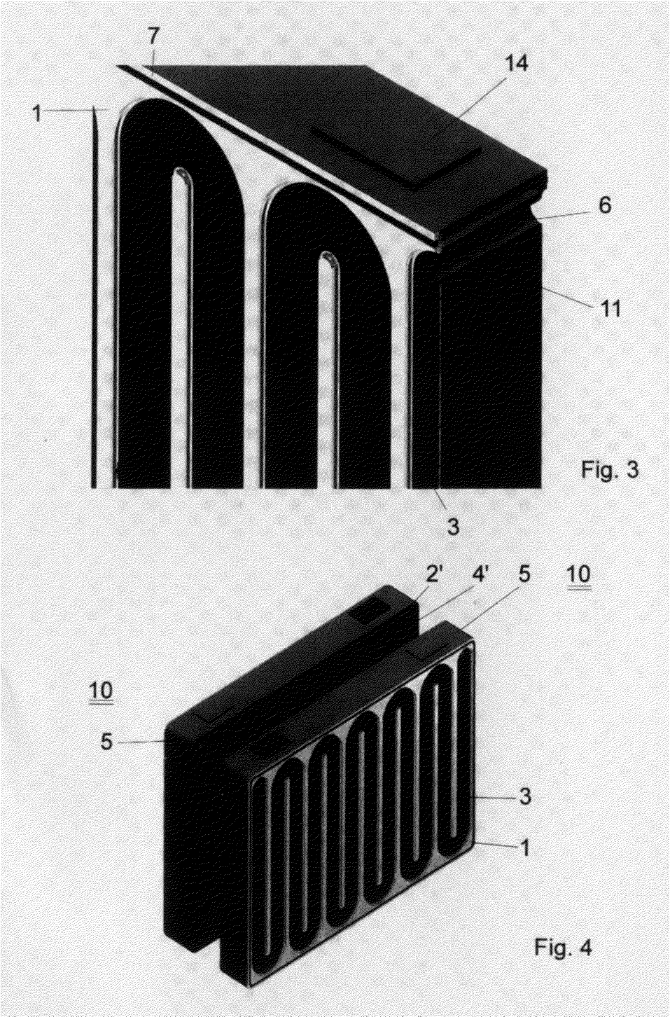

FIG. 4 a schematic depiction of a cell housing arrangement upon battery assembly.

FIG. 1 shows a schematic depiction of a cell housing 5 for an electrochemical cell 10 according to an embodiment of the present invention in a perspective view. The cell housing 5 comprises a first housing side wall 1 in which a meandering first coolant channel 3 is positioned. A coolant flow connection 6 to a second coolant channel on a second housing wall is disposed at one end of the first coolant channel 3. A first contact 13 and a second contact 14 furthermore lead out of the cell housing 5.

FIG. 2 shows a first detail depiction of the cell housing shown in FIG. 1, in which can be recognized the second coolant channel 4 and the second housing side wall 2 with a second sealing member 8 comprising a second groove 12 as well as a first sealing member 7 on the first housing side wall 1, wherein the first sealing member 7 comprises a first groove 11. Upon stacking and subsequent interlocking of the cell housings, the coolant channels on the housing side walls can be outwardly sealed in particularly secure manner.

FIG. 3 shows a second detail depiction of the cell housing shown in FIG. 1, in which can be recognized that the coolant flow connection 6 from one end of the first coolant channel 3 to the first housing side wall 1 leads through the interior of the electrochemical cell 10 within a sealed area to an end of the second coolant channel on the second housing side wall 2.

FIG. 4 shows a schematic depiction of an arrangement of the cell housing 5, 5′ of adjacently arranged electrochemical cells 10, 10′ upon assembly of the electrochemical energy storage. A series connection is realized by an alternatingly rotated arrangement of the electrochemical cells 10, 10′, wherein the coolant flow can be guided from one electrochemical cell to the next via the coolant channels and the coolant flow connections.

### LIST OF REFERENCE NUMERALS

1 first housing side wall
2 second housing side wall
3 first coolant channel
4 second coolant channel
5 cell housing
6 coolant flow connection
7 first sealing member
8 second sealing member
10 electrochemical cell
11 first groove
12 second groove
13 first contact
14 second contact

1. A cell housing for an electrochemical cell for assembly of an electrochemical energy storage, particularly configured for use in a motor vehicle, wherein the cell housing is of substantially rigid configuration, the cell housing comprising:
a first housing side wall; and
a second housing side wall opposite said first housing side wall,
wherein the first housing side wall comprises a first coolant channel and that the second housing side wall comprises a second coolant channel, and
wherein a coolant flow connection from the first coolant channel of the first housing side wall to the second coolant channel of the second housing side wall is further disposed within the cell housing.

2. The cell housing according to claim 1, wherein the coolant flow connection is arranged on one end of the first coolant channel and on another end of the second coolant channel.

3. The cell housing according to claim 1, wherein the first coolant channel is of substantially meandering form over virtually the entire first housing side wall and/or that the second coolant channel is of substantially meandering form over virtually the entire second housing side wall.

4. The cell housing according to any claim 1, wherein the first coolant channel and the second coolant channel are of symmetrical configuration.

5. The cell housing according to claim 4, wherein the first housing side wall of the one cell housing is configured to contact a first housing side wall of an adjacently arranged cell housing and/or wherein the second housing side wall of the one cell housing is configured to contact a second housing side wall of an adjacently arranged cell housing.

6. The cell housing according to claim 5, wherein the first coolant channel is configured such that a connection of the first housing side wall of the one cell housing to a first housing side wall of the adjacently arranged cell housing forms a common coolant channel and/or wherein the second coolant channel is configured such that a connection of the second housing side wall of the one cell housing to the second housing side wall of the adjacently arranged cell housing forms a common coolant channel.

7. The cell housing according to claim 5, wherein the first housing side wall comprises a first sealing member enclosing the first coolant channel, wherein said first sealing member of the one cell housing is configured to connect to a first sealing member of the adjacently arranged cell housing and/or wherein the second housing side wall comprises a second sealing member enclosing the second coolant channel, wherein said second sealing member of the one cell housing is configured to connect to a second sealing member of the adjacently arranged cell housing.

8. The cell housing according to claim 7, wherein the first sealing member comprises a first groove surrounding the first coolant channel and/or that the second sealing member comprises a second groove surrounding the second coolant channel.

9. A battery comprising:
at least two electrochemical cells comprising cell housings in accordance with claim 1, wherein the electrochemical cells are arranged such that the respective first housing side wall of the one cell housing is connected to the first housing side wall of the adjacently arranged cell housing and/or wherein the respective second housing side wall of the one cell housing is connected to the second housing side wall of the adjacently arranged cell housing.

10. A battery comprising:
at least two electrochemical cells comprising cell housings in accordance with claim 8, wherein the electrochemical cells are arranged such that the respective first housing side wall of the one cell housing is connected to the first housing side wall of the adjacently arranged cell housing and/or wherein the respective second housing side wall of the one cell housing is connected to the second housing side wall of the adjacently arranged cell housing.

11. The battery according to claim 10, wherein the respective first sealing member of the one cell housing contacts the first sealing member of the adjacently arranged cell housing and a sealing strip is inserted into the first groove of the first sealing member of the one cell housing and/or into the first groove of the first sealing member of the adjacently arranged cell housing and/or characterized in that the respective second sealing member of the one cell housing contacts the second sealing member of the adjacently arranged cell housing and a sealing strip is inserted into the second groove of the second sealing member of the one cell housing and/or into the second groove of the second sealing member of the adjacently arranged cell housing.

12. The battery according to claim 11, wherein the sealing strip comprises at least one precompressed strip element which expands after being inserted into the first groove and/or after being inserted into the second groove.
